(19) United States
(12) Patent Application Publication
(10) Pub. No.: US 2008/0021959 A1
(43) Pub. Date: Jan. 24, 2008

(54) DIGITAL MEDIA TRANSFER DEVICE

(76) Inventors: Herschel Naghi, Beverly Hills, CA (US); David Naghi, Burbank, CA (US)

Correspondence Address: CHRISTIE, PARKER & HALE, LLP, PO BOX 7068, PASADENA, CA, 91109-7068, US

(21) Appl. No.: 11/733,715

(22) Filed: Apr. 10, 2007

Related U.S. Application Data
(60) Provisional application No. 60/790,895, filed on Apr. 10, 2006.

(51) Int. Cl. G06F 15/17

(52) U.S. Cl. 709/204

(57) ABSTRACT

The present invention relates to a digital media transfer device adapted to transfer compressed digital multimedia files from one digital media device to another digital media device. The digital media transfer device has two ports for interfacing with respective digital media devices so as to copy, swap, or transfer compressed digital multimedia files between the digital media devices. The digital media transfer device may monitor and control copying activities by the user such that the Digital Rights Management (DRM) and/or the user agreement with the content distributor is not violated. The digital media transfer device may also convert the digital media files between various file formats.

### CROSS-REFERENCE TO RELATED APPLICATION(S)

This application claims priority to and the benefit of provisional application No. 60/790,895, filed Apr. 10, 2006, the entire content of which is expressly incorporated by reference herein.

### FIELD OF THE INVENTION

The present invention relates to a digital media transfer device adapted to transfer compressed digital multimedia files from one digital media device to another digital media device.

### BACKGROUND OF THE INVENTION

A variety of digital media devices/players are available on the market today. These devices can be used to listen to audio, display images, and/or display video. These multimedia files may be stored in a variety of file formats, including WMA, WAV, AAC, MP3, MPEG, and many others. The MP3 format is a very common file format for audio files. Many digital media devices are referred to as “MP3 players,” although they may use formats other than the MP3 format. One of the most popular portable digital media devices is the iPod, available from Apple Computer, Inc. (“Apple”), which has a dominant share of the market. Other digital media devices include the Zune, available from Microsoft Corporation, and the SanDisk Sansa, available from SanDisk Corporation.

The iPods restrict the user's choice of audio file format to that of iTunes available from the iTunes Music Store operated by Apple. To date, iTunes have been downloaded or transferred to iPods primarily from a computer (e.g., PC or Macintosh) connected to the Internet. Further, there may be a restriction or limit (e.g., limit of 5 copies at any time) on how many times an iTune purchased by a user from the iTunes Music Store can be copied (or swapped) or how many copies can be had at a time, without violating the user agreement with Apple.

It is desirable to be able to load an iTune to an iPod from another iPod without using a computer, and without violating the user agreement with Apple entered at the time of purchasing the iTune. It is also desirable to be able to use a portable device to transfer compressed digital multimedia files in various formats from one digital media device to another digital media device, and/or to convert them from one file format to another, without requiring the use of a personal computer.

### SUMMARY

In an exemplary embodiment of the present invention, a digital media transfer device is provided. The digital media transfer device has two ports for interfacing with respective digital media devices (e.g., iPod, Zune, SanDisk) so as to transfer or copy or swap compressed digital multimedia files (e.g., iTunes, MP3 files, and/or other audio or video files) between the digital media devices.

The digital media transfer device may monitor and control copying activities by the user such that the Digital Rights Management (DRM) and/or the user agreement with the content distributor is not violated.

In one exemplary embodiment, the digital media transfer device includes a battery or power source, and/or is adapted to receive power from an external power source such that the digital media transfer device does not use or require battery power from the digital media device for its operations.

In one exemplary embodiment, a hand-held digital media transfer device for transferring a media file from a first digital media device to a second digital media device includes a processor; a first port coupled to the processor and configured to couple to the first digital media device; and a second port coupled to the processor and configured to couple to the second digital media device. The processor is programmed to obtain the media file from the first digital media device through the first port and transfer the media file to the second digital media device through the second port.

In another exemplary embodiment, a hand-held digital media transfer device for transferring a media file between a first wireless digital media device and a second wireless digital media device includes a processor; a first wireless port coupled to the processor and configured to wirelessly communicate with the first wireless digital media device; and a second wireless port coupled to the processor and configured to wirelessly communicate with the second wireless digital media device. The processor is programmed to obtain the media file from the first wireless digital media device through the first wireless port and transfer the media file to the second wireless digital media device through the second wireless port.

In another exemplary embodiment, a method of using a hand-held digital media transfer device having a first port and a second port to transfer a media file from a first digital media device to a second digital media device includes receiving the media file from the first digital media device through the first port; altering the media file to indicate that it has been copied or transferred; and transferring the media file to the second digital media device through the second port. The method may also include copying the media file in the hand-held digital media transfer device, and/or converting the media file from a first file format to a second file format.

These and other aspects of the invention will be more readily comprehended in view of the discussion herein and accompanying drawings.

### BRIEF DESCRIPTION OF THE DRAWINGS

FIG. 1 is a block diagram of a digital media transfer device in an exemplary embodiment according to the present invention, wherein the digital media transfer device is coupled to two digital media devices for transfer of compressed digital multimedia files;

FIG. 2 is a schematic plan view of a front side of a digital media transfer device in an exemplary embodiment according to the present invention;

FIG. 3 is a block diagram of a digital media transfer device in an exemplary embodiment according to the present invention, wherein the digital media transfer device is coupled to two wireless adapters for transfer of compressed digital multimedia files;

FIG. 4 is a block diagram of a digital media transfer device in an exemplary embodiment according to the present invention, wherein the digital media transfer device is wirelessly connected to two wireless digital media devices for transfer of compressed digital multimedia files; and

FIG. 5 is a schematic view of a method of transferring a multimedia file in an exemplary embodiment according to the present invention.

### DETAILED DESCRIPTION

A digital media transfer device in exemplary embodiments according to the present invention can be used to copy or swap compressed digital multimedia files between two digital media devices (e.g., MP3 players or iPods) without a personal computer (e.g., PC or Macintosh). The digital media transfer device may also convert the compressed digital multimedia files between various file formats. The digital media transfer device allows the user to comply with Digital Rights Management (DRM) and/or a user agreement with the content distributor, as the device stays within the DRM control of digital medial files (e.g., iTunes). In one embodiment, the digital media transfer device may be referred to as a swapper device or an iLink Swapper device.

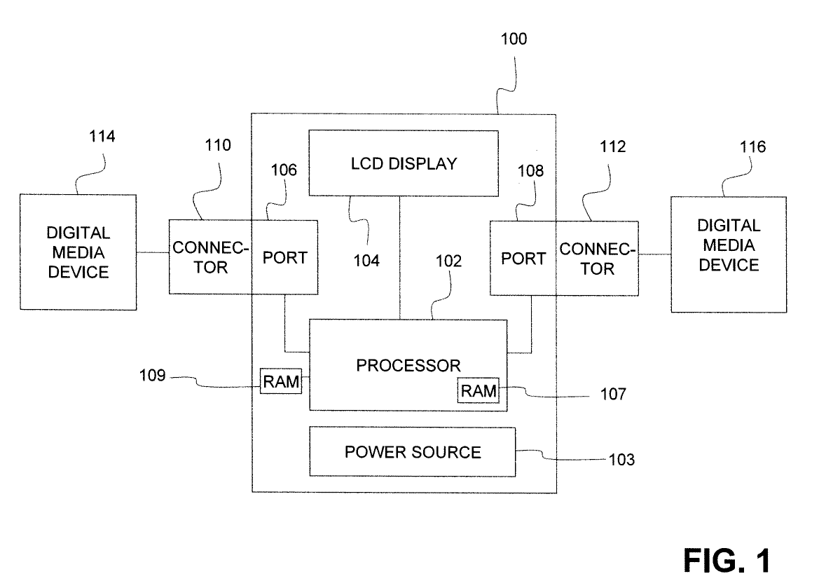

FIG. 1 is a block diagram of a digital media transfer device 100 in one embodiment according to the present invention, coupled to two digital media devices 114 and 116. The digital media transfer device 100 includes a processor 102, an LCD display 104 and two communication ports 106 and 108 coupled to respective connectors 110 and 112. In this configuration, compressed digital multimedia files may be swapped between the digital media devices 114 and 116. In the described embodiment, the processor 102 may be or may include an SPCE536A type CPU available from SunPlus Technology Co., or an equivalent, or any other suitable microprocessor or microcontroller.

The digital media transfer device 100 also includes a power source or battery 103 for providing power to the processor 102, the LCD display 104, and the ports 106, 108 such that the digital media transfer device 100 does not require power from the digital media device 114, 116 for its operation. The power for the power source 103 may be generated/stored internally to the digital media transfer device 100, such as, for example, in the form of an internal battery. The power source 103, alternately, may draw power from an external power supply, such as, for example, a wall outlet or plug. Alternatively, the digital media transfer device 100 may be powered by the digital media devices 114, 116 (e.g., iPods).

The ports 106 and 108 may be On The Go (OTG) USB ports. The ports 106 and 108 may alternatively be any suitable serial or parallel ports known to those skilled in the art. The ports 106 and 108 should be compatible with and suitable for interfacing with interface ports of the digital media devices 114 and 116.

The connectors 110 and 112 may be dock connectors for docking the digital media devices 114 and 116, respectively, to the digital media transfer device 100. The connectors 110, 112 receive the digital media devices 114, 116 to couple them to the respective ports 106, 108. The digital media devices 114, 116 may include their own connectors that are suitable for connecting with the connectors 110, 112 to dock the digital media devices to the digital media transfer device. In one embodiment, the connectors 110 and 112 are suitable for docking iPods thereto. In another embodiment, the connectors 110 and 112 are suitable for docking Zune devices thereto. In other embodiments, the connectors 110 and 112 are suitable for docking one or more digital media devices thereto. The connectors 110, 112 are optional, as the digital media devices may connect directly to the ports 106, 108 without requiring a connector to dock to the digital media transfer device 100.

Although two ports 106, 108 and two connectors 110 and 112 are shown in FIG. 1, the digital media transfer device 100 in another embodiment may include only one port and one connector. The digital media transfer device 100 may have one port and no connectors. A digital media device 114 can be connected to the port to transfer multimedia files through the port to the processor 102, which stores the files in the RAM 107 and/or 109. The digital media device 114 is then disconnected, and the second digital media device 116 is connected to the port to receive the multimedia files stored in the digital media transfer device 100. Thus, a single port can be used to swap files. In other embodiments, more than two ports may be used to swap files.

In the described embodiment, the ports 106 and 108 (e.g., OTG USB ports) allow each iPod or other digital media device to be controlled, and all file handling is maintained through this interface on each iPod. The processor 102 (e.g., SPCE536A type CPU) may be fitted with large externally addressed RAM (random access memory) buffers 109 that allow the buffering of the files as they are transferred between the digital media devices as required. The external RAM 109 may be stored externally of the processor 102 and coupled to the processor 102. In other embodiments, the processor may include internal memory 107 for such buffering of files during the transfer. Internal RAM 107 may be stored inside the processor 102, and may be referred to as “cache” memory. While both internal and external RAM 107 and 109 are shown in FIG. 1, either one may be absent in other embodiments; it is not necessary for both types of RAM to be present. The RAM 107, 109 may also take the form of flash memory or any other suitable memory.

The digital media transfer device 100 may use its RAM 107, 109 to buffer the multimedia files as they are transferred directly between the two digital media devices 114, 116. In this case, the buffering and transferring take place concurrently. Alternatively, or in addition, the digital media transfer device 100 may make and store a complete copy of the media file before transferring it to the second digital media device. Here, the copying and transferring take place sequentially. During any of these steps, the digital media transfer device 100 may also convert the format of the media file and/or alter the media file to indicate that it has been copied or transferred. The digital media transfer device 100 may also compress and/or resample the multimedia file in order to store the file in its onboard memory 107, 109. The digital media transfer device 100 may convert the file into a new format in order to compress it. During this process, the digital media transfer device 100 in one embodiment can access the security content of the file and alter it, as described in more detail below.

The processor 102 in the described embodiment is also capable of controlling the LCD display 104. The LCD display 104 is used by a user to list and to maintain the status of the files that are to be transferred between the digital media devices. The LCD display 104 may also be used to input a user's password or security code, if necessary, when such a password or security code is required in order to transfer or copy the file in compliance with the digital rights or user agreement with the content distributor.

In order to ensure that the digital rights of the copyrighted content and/or the user agreements between the user and the content distributor are not violated, the digital media transfer device 100 can also manipulate the file data that is placed there from or by the content distributor (e.g., iTunes Music Store). By way of example, the iTunes allow a maximum number of swaps or copies of the original file. The digital media transfer device 100 maintains (or keeps track of) the number of swaps or copies and updates the data files on each digital media device to keep the copyrighted content just as secure as with the iTunes program. For example, the iTunes or other multimedia file may have a table of contents which stores security information about the file. In one embodiment, the digital media transfer device 100 may access and read the table of contents stored on the media file to determine whether the file may be copied without violating the user agreement. The digital media transfer device 100 in one embodiment can also alter the table of contents to indicate that the file has been copied. However, in other embodiments, the digital media transfer device does not necessarily alter the file as described above, and may transfer it directly between digital media devices, for example, to transfer files that have no restrictions or user agreements.

The digital media transfer device 100 may also convert compressed digital multimedia files between various formats. The files stored on each digital media device 112, 114 may be audio, video, image, or other multimedia files. These files may be stored in various formats, depending on the type of content, the digital media device, and the content distributor. For example, audio files on iPods may be stored in an iTunes format, such as AAC (Advanced Audio Coding). Audio files on Zune devices may be stored in MP3 format. Other audio files may be stored in WMA (Windows Media Audio), WAV, M4A (Apple Lossless), MPEG-4, AIFF, Speex, Vorbis, or other audio formats. Video and image files may be stored in formats such as MPEG, BMP, JPEG, GIF, QuickTime, WMV, AVI, DivX, and others. Many other file formats are available; this list is intended to be illustrative only, and not limiting. The digital media transfer device 100 may also utilize its own proprietary file format and may convert the media file into this format in order to store, compress, buffer, or transfer it.

The digital media transfer device 100 can obtain a file from one digital media device 114 and convert it from its native or existing file format into a different file format. The new file, in the new format, can then be transferred to the other digital media device 116. Thus, the digital media transfer device 100 has the ability to convert media files from one format to another to transfer the files between different types of digital media devices 114, 116, even when the digital media devices store files in incompatible file formats. For example, in one embodiment, the digital media transfer device 100 can convert an MP3 file to an AAC file in order to transfer the file from a Zune to an iPod. Many other types of conversions are possible. The digital media transfer device 100 may also use an intermediary file format to accomplish this conversion; for example, it may obtain the media file in a first format from the first digital media device, convert the file into a second, intermediate file format, and then convert the file into a third file format for transfering to the second digital media device.

The digital media transfer device 100 can convert and transfer files between digital media devices without requiring a personal computer, such as a PC or Macintosh. The digital media transfer device is hand-held and portable, with a size small enough to be convenient to carry. The digital media transfer device enables users to copy, transfer, alter, and/or convert media files between digital media devices on demand, while away from the home or office computer.

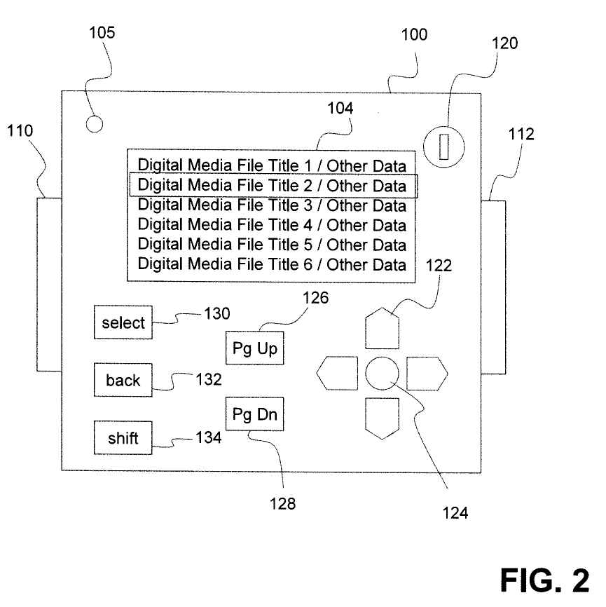

A plan view of the digital media transfer device 100 is shown in FIG. 2. It can be seen in FIG. 2 that on the LCD display 104, a number of file titles 1-6 are displayed. Other data associated with each compressed digital multimedia file may be displayed on the LCD display 104 as well. Each file may include digital video, images, audio, or other media in any suitable format (e.g., iTune format).

The digital media transfer device 100 has control buttons 122 that allow the directional movement of a highlighted cursor. This allows the user to select the files (e.g., music or video files) for file swapping with other digital media devices. The control buttons 122 in the described embodiment have a shape of four (4) directional arrow control buttons. The control buttons 122 may have other shapes in other embodiments.

The digital media transfer device 100 also includes an on/off switch 120, page up and page down buttons 126 and 128, a select button 130, a back button 132 and a shift button 134. The shift button 134 may allow activation of more complex features. The back button 132 may make clearing or navigation through the menus and/or selection of functions easier. The digital media transfer device also includes a start/pause button 124 for starting and stopping the play of the media file and/or the file transferring process.

It can be seen in FIG. 2 that the LCD display includes six (6) rows of file titles 1-6. In other embodiments, the number of rows displayed on the LCD display may be more or less than six. When the title and/or other data of the one or more media files are too long, and therefore cannot be displayed on a single line, the LCD display will show scrolling in-line characters to allow the reading of the full content. By way of example, the compressed digital multimedia file for copying or swapping can be selected by pressing the select button 130 while the corresponding compressed digital multimedia file title is highlighted (e.g., by a cursor) in the LCD display. It can be seen in FIG. 2, for example, the digital media file Title 2 is highlighted.

The digital media transfer device 100 also includes an indicator 105 (e.g., LED indicator) for indicating a status of file transfer or swapping based on the transfer speed and the size of the file being transferred/swapped. Additionally or alternatively, the file transfer status may be displayed on the LCD display 104. Hence, the indicator 105 and/or the LCD display 104 can inform the user of the file transfer/swap status during and upon completion of the file transfer/swap.

Also, while connectors (e.g., dock connectors) or adapters 110 and 112 are shown in FIG. 2, the digital media transfer device 100 may be coupled to the digital media devices via wires or cables or connectors at one or both ends. Further, one or both interfaces between the digital media transfer device and the digital media devices may be wireless connections using such communications protocols/formats as Bluetooth, infrared, WiFi, 802.11, and/or any other suitable communication protocols/formats as those skilled in the art would appreciate.

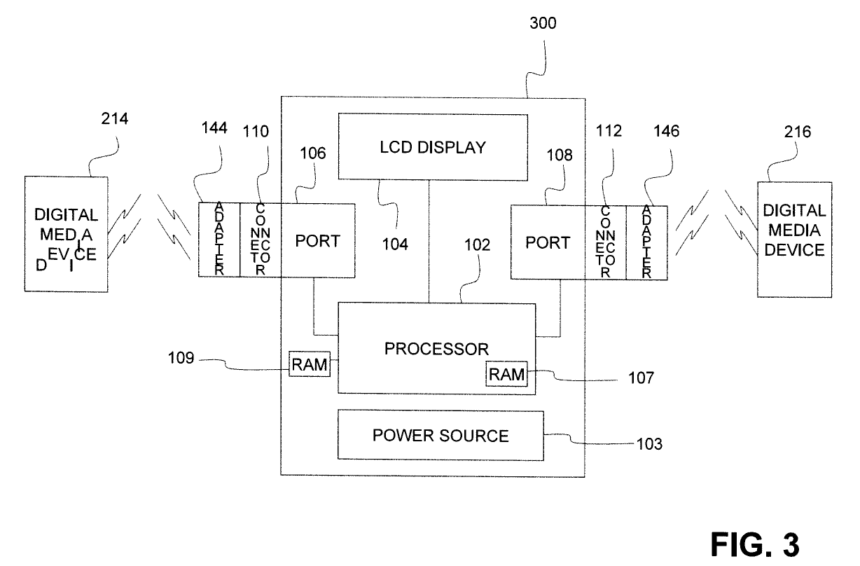

Referring to FIG. 3, a digital media transfer device 300 is shown with two wireless adapters 144, 146 coupled to the connectors 110, 112 and ports 106, 108. The wireless adapter is sometimes referred to as a “dongle.” The wireless adapters 144, 146 allow the digital media transfer device 300 to communicate with the digital media devices 214, 216 wirelessly, so that the digital media devices do not have to be physically connected to the connectors 110 and 112. A digital multimedia file is transmitted from one of the digital media devices 214 through the wireless adapter 144 to the port 106, where it is received by the digital media transfer device 300 for transferring, copying, and/or converting the file. The copied file can then be wirelessly transmitted to the second digital media device 216 through the second wireless adapter 146. In one embodiment, either or both adapters may be removed from the digital media transfer device 300 when the device 300 needs to communicate with a digital media device that lacks wireless capability. For example, the adapter 144 can be removed from the port 106, and a digital media device without wireless capability can be physically connected to the port 106 and connector 110, as shown in FIG. 1. Thus, the digital media transfer device 300 has the ability to make wired or wireless connections with the digital media devices.

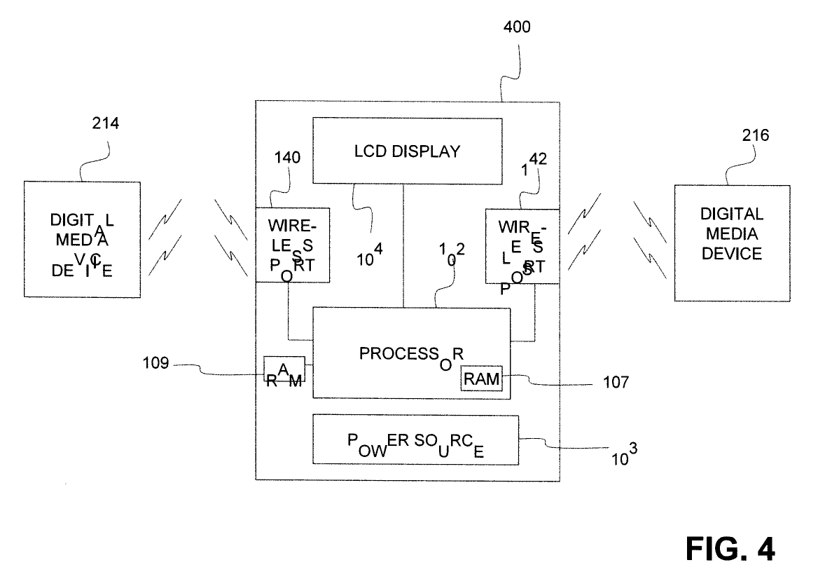

Referring to FIG. 4, a digital media transfer device 400 is shown with two wireless ports 140 and 142. The wireless ports 140, 142 communicate directly with the wireless digital media devices 214, 216. The wireless ports do not require the wireless adapters or dongles 144, 146 (shown in FIG. 3) in order to communicate wirelessly with the digital media devices. In this embodiment, the connectors 110, 112 are not needed, as the wireless digital media devices 214, 216 are not physically docked to the digital media transfer device 400. One or both of the digital media devices 214 and 216 may also have a wireless adapter for converting a wired digital media device into a wireless digital media device.

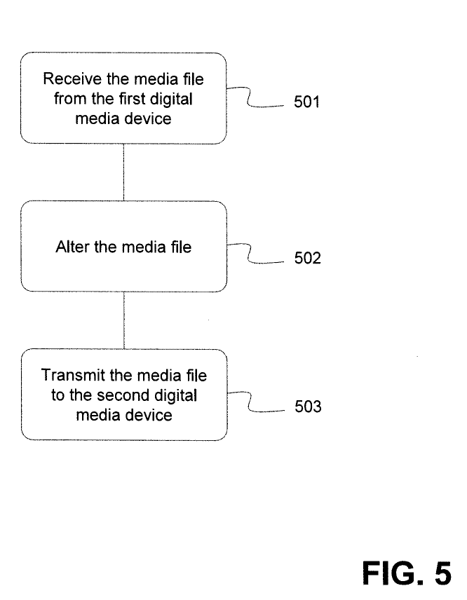

Referring to FIG. 5, a method of transferring digital media files between digital media devices is shown. The method includes receiving the media file from the first digital media device 501. The digital media transfer device receives the multimedia file through the first port 106 or wireless port 140. The method then includes altering the media file 502. The digital media transfer device can alter the compressed digital multimedia file to indicate that it has been copied or transferred. The altering may involve format conversion of the media file (e.g., from the AAC format to the MP3 format or vice versa). The method also includes transmitting the media file to the second digital media device 503. The digital media transfer device transmits the file to the second digital media device through the second port 108 or wireless port 142.

In one embodiment, a copy may be made by the digital media transfer device and stored first, prior to transferring the file to the second digital media device. In such an embodiment, the digital media transfer device obtains the media file from the first digital media device and stores the file on its onboard memory 107, 109. The digital media transfer device can then buffer and convert the file, if necessary, and then transfer the file to the second digital media device. In still other embodiments, altering and copying may take place concurrently. In such an embodiment, the digital media transfer device may have a smaller amount of onboard memory 107, 109. The digital media transfer device obtains the multimedia file from the first digital media device, and buffers it and sends it directly to the second digital media device, without storing a complete copy. The method may also include converting the multimedia file from a first file format to a second file format, and/or altering the file to indicate that it has been copied.

While certain exemplary embodiments of the present invention have been described above in detail and shown in the accompanying drawings, it is to be understood that such embodiments are merely illustrative of and not restrictive of the broad invention. It will thus be recognized that various modifications may be made to the illustrated and other embodiments of the invention described above, without departing from the broad inventive scope thereof. In view of the above, it will be understood that the invention is not limited to the particular embodiments or arrangements disclosed, but is rather intended to cover any changes, adaptations or modifications which are within the spirit and scope of the present invention.

What is claimed is:

1. A hand-held digital media transfer device for transferring a media file from a first digital media device to a second digital media device, comprising:
a processor;
a first port coupled to the processor and configured to couple to the first digital media device; and
a second port coupled to the processor and configured to couple to the second digital media device,
wherein the processor is programmed to obtain the media file from the first digital media device through the first port and to transfer the media file to the second digital media device through the second port.

2. The hand-held digital media transfer device of claim 1, further comprising a display panel coupled to the processor to display information regarding the media file.

3. The hand-held digital media transfer device of claim 1, further comprising a plurality of control buttons coupled to the processor.

4. The hand-held digital media transfer device of claim 1, further comprising an indicator coupled to the processor to indicate a status of the media file.

5. The hand-held digital media transfer device of claim 1, further comprising an internal battery coupled to the processor to provide electrical power to the processor.

6. The hand-held digital media transfer device of claim 1, wherein the processor is further programmed to convert the media file from a first file format to a second file format.

7. The hand-held digital media transfer device of claim 1, wherein the processor further comprises internal memory for storing the media file.

8. The hand-held digital media transfer device of claim 1, further comprising memory coupled to the processor for storing the media file.

9. The hand-held digital media transfer device of claim 1, further comprising a wireless adapter coupled to the first port for wirelessly communicating with the first digital media device.

10. The hand-held digital media transfer device of claim 9, further comprising a second wireless adapter coupled to the second port for wirelessly communicating with the second digital media device.

11. The hand-held digital media transfer device of claim 1, wherein the processor is programmed to alter the media file to indicate that the media file has been copied or transferred.

12. A hand-held digital media transfer device for transferring a media file between a first wireless digital media device and a second wireless digital media device, comprising:
a processor;
a first wireless port coupled to the processor and configured to wirelessly communicate with the first wireless digital media device; and
a second wireless port coupled to the processor and configured to wirelessly communicate with the second wireless digital media device,
wherein the processor is programmed to obtain the media file from the first wireless digital media device through the first wireless port and to transfer the media file to the second wireless digital media device through the second wireless port.

13. The hand-held digital media transfer device of claim 12, wherein the processor is further programmed to copy the media file.

14. The hand-held digital media transfer device of claim 12, wherein the processor is further programmed to alter the media file to indicate that the media file has been copied or transferred.

15. The hand-held digital media transfer device of claim 12, wherein the processor is further programmed to convert the media file from a first file format to a second file format.

16. A method of using a hand-held digital media transfer device having a first port and a second port to transfer a media file from a first digital media device to a second digital media device, comprising:
receiving the media file from the first digital media device through the first port;
altering the media file to indicate that it has been copied or transferred; and
transferring the media file to the second digital media device through the second port.

17. The method of claim 16, further comprising copying the media file in the hand-held digital media transfer device.

18. The method of claim 16, further comprising converting the media file from a first file format to a second file format.

19. The method of claim 16, wherein the receiving the media file from the first digital media device through the first port comprises wirelessly communicating with the first digital media device, and wherein the transferring the media file to the second digital media device through the second port comprises wirelessly communicating with the second digital media device.
